(19) United States
(12) Patent Application Publication
(10) Pub. No.: US 2022/0379237 A1
(43) Pub. Date: Dec. 1, 2022

(54) EXTERNALLY MODULATED VARIABLE AFFINITY CHROMATOGRAPHY

(71) Applicant: Arizona Board of Regents on Behalf of the University of Arizona, Tucson, AZ (US)

(72) Inventor: Hamish S. Christie, Tucson, AZ (US)

(73) Assignee: Arizona Board of Regents on Behalf of the University of Arizona, Tucson, AZ (US)

(21) Appl. No.: 17/761,197

(22) PCT Filed: Sep. 16, 2020
(86) PCT No.: PCT/US2020/051140

§ 371 Date: Mar. 17, 2022

Related U.S. Application Data
(60) Provisional application No. 62/901,563, filed on Sep. 17, 2019.

(51) Int. Cl. B01D 15/36; B01D 15/38; B01J 20/32

(52) U.S. Cl. CPC B01D 15/364; B01D 15/3804; B01D 15/3885; B01J 20/3285

(57) ABSTRACT

This present invention is directed to variable affinity chromatography apparatus and methods for using the same. In particular, the polarity of the stationary phase or the mobile phase is modulated using an external stimulus. Exemplary external stimulus that can be used in the invention include, but are not limited to, electric field, electromagnetic radiation including UV, Vis, and infrared wavelengths, as well other stimuli that are known to one skilled in the art. Generally, any external stimulation that changes the polarity of a stimulus responsive material can be used. One particular embodiment of the invention provides a chromatography apparatus comprising: (i) a chromatography column having a stationary-phase separation medium contained therein; (ii) an external stimulus generator operatively connected to said chromatography column; and (iii) a chromatography mobile-phase, wherein at least one of said stationary-phase separation medium and said chromatography mobile-phase comprises a stimulus responsive material that adopts a different configuration based on the absence or the presence of said external stimulus, wherein different configurations of said stimulus responsive material results in a different stationary or mobile phase affinity, and wherein said external stimulus is selected from the group consisting of electric field, electromagnetic radiation, and a combination thereof.

### CROSS-REFERENCE TO RELATED APPLICATIONS

This application claims the priority benefit of U.S. Provisional Application No. 62/901,563, filed Sep. 17, 2019, which is incorporated herein by reference in its entirety.

### FIELD OF THE INVENTION

This invention relates to variable affinity chromatography apparatus and methods for using the same. In particular, the polarity of the stationary phase or the mobile phase is modulated using an external stimulus.

### BACKGROUND OF THE INVENTION

Chromatography is one of the most effective analytical techniques to separate, identify, and quantify components in a mixture. Chromatography is used to separate substances by utilizing the substance-specific distribution ratio (for example, the adsorption or partition equilibrium) between a porous stationary phase (e.g., solid phase) that is spatially immobilized in a column or a tube known as a chromatography column or a capillary, and a fluid (the mobile phase) that moves in the spaces in the porous solid. Gas chromatography and liquid chromatography are typical chromatography methods known to one skilled in the art. In general, gas chromatography is used (with gas as the mobile phase) in separation and analysis of a compound, whereas liquid chromatography, due to the larger capacity, is often used for both analytical and preparative scale separation of compounds. It appears that chromatography is rarely used for large-scale purifications due primarily to the large amounts of solid phase material and solvent (mobile phase) required relative to the amount of material being separated. Thus, conventional chromatography methods to separate and recover the desired component are often prohibitively cumbersome and expensive. Typically, extraction, distillation, and recrystallization are the preferred methods on large scale.

In chromatography, the components to be separated are distributed between two phases, a stationary (typically solid) phase (generally contained in a column) and a mobile phase (e.g., liquid or gas) which is passed through the stationary phase. The differential rates of migration of components through the stationary phase produces a separation of the components.

One of the key parameters affecting the speed and quality of some types of liquid chromatography separation is the polarity of the stationary phase and/or the mobile phase used in the separation. Polarity of a stationary phase determines the amount of time that a given component remains attached to the stationary phase. In addition, polarity of the mobile phase also determines the how fast each component moves through the chromatography column. Changing these parameters during a separation can modulate the rate of elution of components from a chromatography column resulting in improved separation of components. Usually, this is achieved by varying the composition of the mobile phase being delivered to the column. It is believed that if one can modify the polarity of the stationary phase and/or the mobile phase using an external stimulus, one can realize previously unknown levels of separation resolution and that one can also effectively separate a desired component on a large scale commensurate in scope with that of distillation, recrystallization, and extraction processes that are currently used for a large-scale purification.

Therefore, there is a need for a method of modulating polarity of the stationary phase and/or the mobile phase to increase the speed and/or efficiency of chromatography separations.

### SUMMARY OF THE INVENTION

Some aspects of the invention relate to a chromatography apparatus that allows an external stimulus to modulate the polarity of various portions of chromatography elements such as a stationary-phase, a mobile-phase, or both. Advantages of such a method allow chromatography methods of the invention to be superior to current chromatography methods and competitive with or better than other purification methods such as extraction, distillation, or recrystallization. Furthermore, by utilizing a computer or a central processing unit device and analyzing the chromatography sample(s) (e.g., continuously or intermittently), one can automate the method, thereby increasing the possible resolution and significantly reducing the labor and time costs in separating a desired component.

In one particular aspect of the invention, a chromatography apparatus is provided that comprises:
a chromatography column having a solid-phase separation medium or a stationary-phase contained therein;
an external stimulus generator operatively connected to said chromatography column; and
a chromatography solvent.
   At least one of the stationary-phase separation medium or the mobile-phase comprises a stimulus responsive material that adopts different configurations, or orientations, based on the absence or the presence of the external stimulus that is generated by the external stimulus generator. The different configurations of the material result in a different polarity of the medium containing the stimulus-responsive material. Exemplary external stimuli that are useful in the invention include, but are not limited to, electric field, irradiation (e.g., electromagnetic radiation including UV, Vis, and infrared), and a combination thereof.

In some embodiments, the apparatus comprises a plurality of external stimulus generators, which allows the intensity of the stimulus to be varied at any position. In this manner, segments or portions of the chromatography column can be modulated to provide different polarity for separating a mixture. Still in other embodiments, the apparatus comprises a plurality of chromatography columns. In this manner, each individual column can be used to separate different compound(s) from the mixture or to provide a higher separation of a desired compound from the mixture. Yet in other embodiments, the apparatus can include a plurality of external field generators both in a single chromatography column as well as having a plurality of chromatography columns. Still in other embodiments, methods of the invention provide a continuous external field modulation.

Still in some embodiments, the apparatus further comprises a solvent delivery device operatively connected to said chromatography solvent. The solvent delivery apparatus delivers said chromatography solvent to said chromatography column. It can be programmable such that the apparatus can be operated automatically. For example, using real-time analysis at various points along the column (e.g., by analyzing small samples, for example, by mass-spectroscopy, UV, or other well-known detection methods) one can be informed about when to switch the stimulus on or off to increase separation efficiency. Such control of stimulus can be managed by a computer or other central processing unit equipped device to provide an optimal separation process.

In one particular embodiment, the stimulus responsive material comprises a zwitterion. The zwitterion typically comprises an anionic moiety and a cationic moiety. Suitable anionic moieties include, but are not limited to, a carboxylate, phosphate, phosphonate, sulfate, sulfonate, sulfonamide anion, and borate. Suitable cationic moieties of the zwitterion include, but are not limited to, a cationic moiety selected from the group consisting of a quaternary amine, iminium, pyridinium, imidazolium, phosphonium, sulfonium, and carbocation (e.g., triarylmethyl). These stimulus responsive materials can be added as an addition to conventionally used solid phase such as silica, alumina, and other chromatography solid-phase materials conventionally used and/or known to one skilled in the art. The amount of stimulus responsive material added can vary depending on a variety of factors such as the physical characteristics of the material(s) to be separated or purified, solvent(s) used, flow rate of the mobile phase, etc.

In one particular embodiment, said zwitterion is a compound of the formula: X-L-Y, wherein X is a cationic moiety, Y is an anionic moiety, and L is a linker having from about 2 to about 20 atoms in a chain. It should be appreciated that the number of atoms in a linker refers to the smallest number of atoms that link X and Y moiety. Thus, typically a linker has from about 2 to about 20 atoms in a chain, where each atom is selected from the group consisting of C, O, N, S, P, provided same two heteroatoms are not next to each other or form an unstable compound under the conditions used for chromatography. Typically, the linker comprises C atoms that are optionally interdispersed with one or more heteroatoms.

The zwitterion can be covalently attached to said stationary-phase. It should be appreciated, however, the zwitterion can also be attached to the stationary-phase by other means such as, by ionic-bonding, Vander Waal's force, etc. as long as the zwitterion can remain stationary within the stationary phase during chromatography.

In another embodiment, or in addition, the zwitterion can be added to the mobile phase. If the zwitterion is present in both the stationary phase and the mobile phase, the zwitterion can be the same or different.

In further embodiments, the chromatography apparatus of the invention can also include a central processing unit (CPU), such as a computer or other devices that can automate the modulation of the external stimulus. In some instances, the chromatography apparatus of the invention can also include a detection device that is operatively connected to the external stimulus device or the CPU unit. In this manner, the mobile phase from the chromatography can be analyzed, at any point along the length of the column, in real-time and the external stimulus can be modulated accordingly.

Another aspect of the invention provides a method for purifying a mixture of compounds. The mixture includes at least a first compound and a second compound. The method generally includes:
placing the mixture of compounds into a chromatography column disclosed herein; and
separating at least a portion of said first compound from said second compound using an external stimulus to modulate the affinity of said solid-phase separation medium or polarity of said chromatography solvent or both.

The external stimulus can be an electric field, irradiation, or a combination thereof. Typically, any stimulus that can influence the conformation or orientation of the stimulus responsive material can be used.

The method can include using a plurality of said external stimulus generators, which allows the intensity of the stimulus to be varied at any position, to effect polarity changes in various segments/portions of the chromatography column and/or the solvent. Such external stimulus field can be applied continuously or intermittently.

Still another aspect of the invention provides a stationary-phase separation medium comprising silica, alumina, polymer, or other separation medium known to one skilled in the art, and a zwitterion. In some embodiments, the zwitterion is immobilized on the silica. In other embodiments, the zwitterion is covalently attached to the silica. Yet in some particular embodiments, the zwitterion is selected from a compound of the formula: X-L-Y, wherein X is a cationic moiety, Y is an anionic moiety, and L is a linker having from about 2 to about 20 atoms in a chain, and wherein said silica is covalently attached to L.

In another embodiment, the stimulus responsive material is “activated” by irradiation. As used herein, the term “irradiation” refers to utilizing electromagnetic radiation, e.g., UV/Vis light and infrared radiation, to change the conformation and/or affinity of the stimulus responsive material to a compound to be separated by chromatography. Suitable stimulus responsive materials that are activated by irradiation include, but are not limited to, azobenzene or other azoaromatic or azoheteroaromatic compounds, diarylethenes, diheteroarylethenes, quinones, spiropyrans, spirooxazines, etc.

### BRIEF DESCRIPTION OF THE DRAWINGS

FIG. 1 is a schematic illustration of one particular embodiment of a chromatography apparatus of the invention, where electric field is used as an external stimulus.

FIG. 2 is a schematic illustration of a typical conventional chromatography.

FIG. 3 is a schematic illustration of a possible separation of materials achieved using a chromatography apparatus of the invention.

FIG. 4 is a schematic illustration of an incomplete separation using a conventional normal phase column.

FIG. 5 is a schematic illustration of a process for cycling the mixed sample back and forth through the chromatography apparatus of the invention to achieve a significantly better separation compared to the conventional normal phase column illustrated in FIG. 4.

FIG. 6 shows one specific example of a polarity modulating compound that can be used in a solid phase of the chromatography apparatus of the invention. The compound, shown on the left, has the charged groups associated intramolecularly in the absence of an electric field. As shown on the right, when an electric field is applied, charged groups are separated and aligns with an applied electric field.

FIG. 7 shows one specific example of a polarity modulating compound that can be used in a mobile phase of the chromatography apparatus of the invention.

### DETAILED DESCRIPTION OF THE INVENTION

Chromatography provides an excellent method for the separation of all types of compounds and has broad utility on both analytical and preparative scales. For example, in a synthetic organic chemistry research laboratory it is the main method for the purification of the majority of compounds generated. Use of chromatography for preparative scale purification becomes less desirable as scale increases. When compared to other methods, such as recrystallization or distillation, purification of large amounts of material requires prohibitively large quantities of adsorbent and solvents. The apparatuses and methods disclosed herein improve both separation and process efficiency, greatly enhancing the utility of chromatography, both as an analytical tool (e.g. HPLC) and as a preparative separation method.

Chromatography involves loading a sample onto a column of stationary phase having a particular affinity strength and eluting with a mobile phase. In conventional chromatography, the polarity or the affinity strength of the solid phase cannot be changed during a separation process. Thus, in many instances variation of the composition of the mobile phase is used to control the polarity, and hence the rate of elution of components from the column. As expected, variation in the composition of the mobile phase requires mixing at least two different solvents and often requires a large amount of solvents.

In contrast to composition variation of the mobile phase, some aspects of the invention provide a method for reversibly varying the polarity properties of the mobile phase and/or the polarity or affinity of the stationary phase, without changing its chemical composition, during the elution process. Use of this type of variable polarity without varying the composition of the mobile phase and the stationary phase allows a range of enhancements of chromatography performance including, but not limited to, increased resolution, reduced solvent volume requirement, and/or reduced processing/handling time.

One particular aspect of the invention provides a method for changing the adsorbing properties of the stationary phase. In this embodiment, as the separation progresses a portion of the chromatography column, e.g., a zone (or zones) is switched from high to low affinity (or vice versa) for components passing through it. By using this method, a number of useful effects on the separation and recovery processes are provided. The process includes applying an external stimulus such as, but not limited to, electric field, and/or electromagnetic field, such as UV/VIS light.

Another aspect of the invention provides a method for modulating the polarity properties of the mobile phase, without changing its chemical composition. Use of this type of variable polarity mobile phase also allows a range of enhancements of chromatography performance, including increased resolution and reduced processing/handling.

Still another aspect of the invention provides a method for modulating the polarity property of both the stationary phase and the mobile phase without changing any chemical composition of either of the phases.

The present invention will be described with regard to the accompanying drawings, which assist in illustrating various features of the invention. In this regard, the present invention generally relates to modulating the polarity of the solid-phase, mobile-phase, or both in chromatography without changing the chemical composition of either. That is, the invention relates to an apparatus and a method for performing chromatography with modulation of polarity of solid-phase, mobile-phase, or both. For the sake of clarity and brevity, the present invention will now be described in reference to using an electric field to modulate polarity in chromatography. However, it should be appreciated that the scope of the invention is not limited to using an electric field to modulate polarity. In fact, as stated above, methods and apparatuses of the invention can include using, electric field or irradiation in modulating polarity of stationary-phase, mobile-phase, or both. Discussion on using electric field in modulating polarity in chromatography is provided solely for the purpose of illustrating the practice of the invention and does not constitute limitations on the scope thereof.

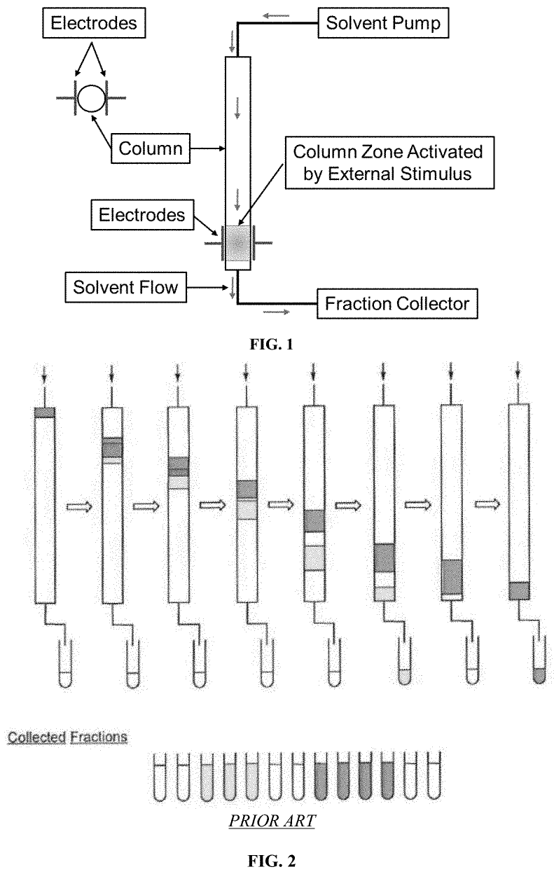

Some embodiments of the chromatography apparatuses of the invention are schematically illustrated in FIG. 1. As an illustrative example, typically the column cross-section is cylindrical, but may be oval-shaped, square, rectangular, or other shapes. The column diameter may range from less than 1 mm to greater than 1 m. There are a variety of factors that can determine a suitable column diameter, such as, but not limited to, the separation parameter (i.e., R_{f} value or the retardation factor, which is defined as the ratio of the distance traveled by the center of a spot to the distance traveled by the solvent front or the mobile phase) column length, the polarity of the mobile phase, the polarity of the stationary phase, flow rate, etc. Column length to diameter ratios are typically between 0.5:1 and 100:1. However, it should be appreciated that the scope of the invention is not limited to any particular column diameter or the column length to diameter ratio.

The column may be constructed from any material suitable for resisting the operating pressure within the column and resisting chemical attack by the mobile phase. Suitable materials include, but are not limited to, glass, stainless steel, aluminum, aluminum alloys, brass, Monel®, ceramics, polymers (e.g., nylon, PEEK, ABS, Teflon®, polypropylene, polyethylene, and others). The region separating the column packing from the external stimulus (e.g., electrodes in FIG. 1) is typically made from a non-conducting material, for example, a ceramic or polymer material. Physical strength may come from the column encasing external to the electrodes. The column wall thickness is appropriate to the material being used.

Solvent pumps can be any of a range of commonly available as in the type used for HPLC. Solvent pump(s), detectors, and fraction collector can all be obtained, constructed, and/or arranged from well-known, and readily available products and materials by one skilled in the art.

Electrodes are typically made from copper, brass, or some other suitable electric conducting materials. The size and shape are generally determined by the size and shape of the required electric field. Voltages used to generate the electric field are typically between 1-60,000 volts. However, it should be appreciated that the useful voltage is not limited to these particular ranges.

In FIG. 1, a chromatography column is filled with a separation medium (e.g., a stationary or solid phase). Typical separation media used in chromatography include, but are not limited to, silica, alumina, polymer, resins, and others that are known to one skilled in the art. Many different particle sizes of silica and alumina are commercially available. In general, a finer sized separation medium offers better separation of chemical components. It should be appreciated that the chromatography column need not be filled 100% with a separation medium. As can be seen in FIG. 1, the external field generator(s) are placed externally to the chromatography column. In FIG. 1, the external field generator is operatively connected to the chromatography column only on the bottom. However, it should be appreciated that any number of external field generators can be present throughout the length of the column. The external field generators configuration shown in FIG. 1 is merely an illustrative example, and the scope of the invention includes placing one or more external field generators anywhere along the length of the chromatography column, which allows the intensity of the external stimulus to be varied at any position. The external stimulus, in this case an electric field, can be applied intermittently and/or continuously as desired.

The external field generator can fully encapsulate a portion of the chromatography column, i.e., the external field generator can be a donut-shaped device, e.g., it can be a concentric circle that surrounds the chromatography column. It can also simply be a prong that surrounds only a portion of the chromatography column. The scope of the invention includes all shapes or forms of the external stimulus generator as long as the external field generator can sufficiently modulate the polarity of the solid-phase, mobile-phase, or both. As used herein, the term “external stimulus generator” means a device that generates a stimulus field that is not part of the separation and/or the mobile phase. Such a device can be embedded within the separation medium or it can be placed external to the separation medium.

A conventional chromatography separation is illustrated in FIG. 2, which shows a typical separation using normal phase liquid-liquid column chromatography. Each picture of the column shows the same column at a different point in time (time progressing from left to right), as eluent is flowing through it (from top to bottom). When a portion of the stationary phase is made more polar (variable stationary phase at the lower part of the column, FIG. 3) all components elute more slowly through that part of the column. A broadened band of separated compound is concentrated into a narrow band within the zone of increased stationary phase polarity, then released as a more concentrated solution when the variable zone is returned to its original state.

One of the advantages of the present invention is the amount of solvent used in collecting the desired component is significantly less. Using the chromatography apparatus of the invention that uses an external field generator, e.g., FIG. 1, one can concentrate the desired product such that the total volume of solvent is significantly less (see FIG. 3) than the volume of solvent containing the desired product using a conventional chromatography method (FIG. 2). In some embodiments, the total volume of collected fractions containing the desired product using the method or the chromatography apparatus of the invention relative to a similar conventional method (e.g., with the same amount of solid phase separation medium, column diameter, elution rate, and the elution solvent) is at least about 10% less, typically at least about 20% less, often at least about 30% less, and most often at least about 50% less. In addition to using significantly less solvent, obtaining the purified compound in a more concentrated solution facilitates subsequent recovery of the sample (less evaporation time, smaller apparatus, etc.). Also, the volume of “clean” solvent eluting from the column is greater (easier recycling, less waste). Using this method, it is possible to use a single solvent or constant solvent composition for the chromatography, this greatly facilitates the recycling of solvents, as separation and remixing of solvents are unnecessary. The solvent saving aspects make the present invention attractive for large scale chromatographic separations.

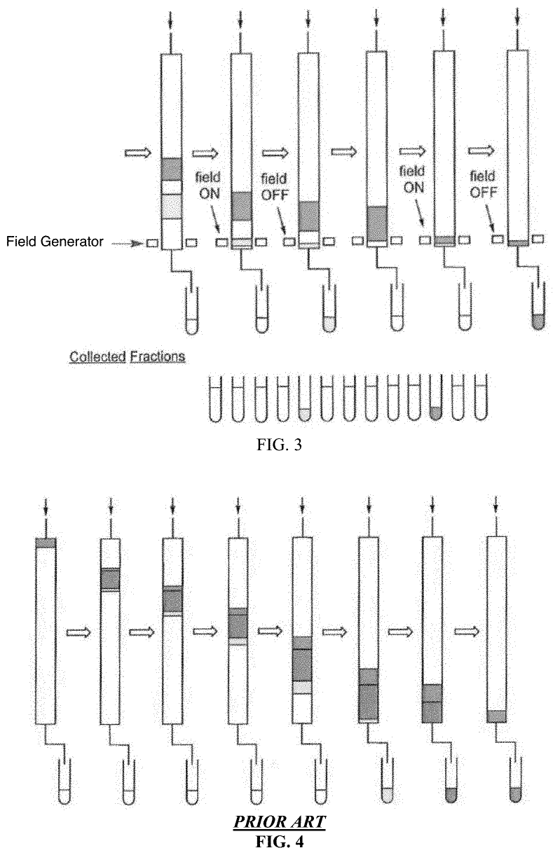

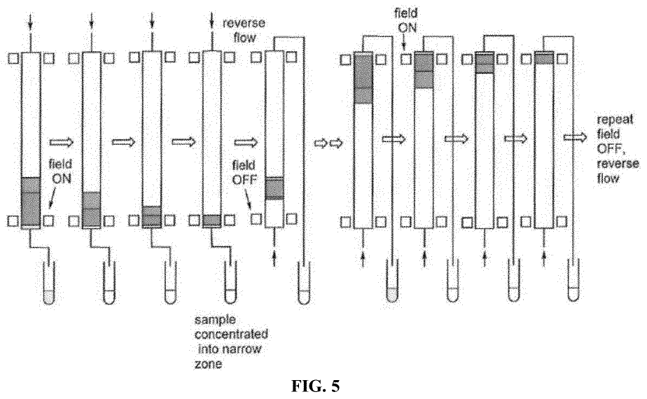

Using the variable polarity of the stationary phase concentrating zones, a separation that is not effective with a single pass through the column can be made to occur by cycling the sample back and forth through the same column, enabled by the variable polarity stationary phase. FIG. 4 illustrates the result for an incomplete separation using a conventional normal phase column. FIG. 5 illustrates the process for cycling the mixed sample back and forth through the column using a chromatography apparatus of the invention. Referring to FIG. 5, when partial separation occurs any pure first eluting component is collected in the normal manner. Then the concentrating zone is activated (i.e., external field is activated to modulate polarity of the stationary-phase) to capture the mixture, concentrating it into a narrow zone. The flow through the column is next reversed, separation again occurs, giving some more of the pure faster eluting compound. The mixed sample again is concentrated, then sent through the column in the original direction once more. This process is continued until complete separation of the faster eluting component is achieved. This process, in principle simulates a column of much greater length, but more efficient for a given path length due to the regular refocusing of the sample band. By comparison, using standard column chromatography methods (e.g., FIG. 4), each cycle of this separation requires eluting the mixed portion from the column, concentrating the sample (evaporating the solvent), and reintroducing it to the column (the same or another column).

Some other advantages of the present invention include, but are not limited to: (1) Reduced column size—the present invention allows for overloading a column relative to its typical optimum capacity as required in conventional methods, thus significantly reducing the size of column necessary for a particular application; and (2) Continuous sample loading—Chromatography is typically conducted as a batch process where a bolus of sample is added to the column, then eluted. A continuous process can be utilized in the apparatuses of the invention such that more mixed sample can be added during the concentration phases, also leading to a greatly reduced apparatus size for a given application.

The particular methods of the invention described above use the variable zone, or zones, by effectively switching them on (very high polarity) or off (low polarity) to produce the desired effects. The column zone properties can also be modulated somewhere between on or off extremes. It should be appreciated that one can place a plurality of external field generators along the length of the column, or a continuum external field generator that can all be controlled. Incorporating these features allows opportunities to fine-tune control and consequently enhanced separations.

The apparatuses and methods of the invention can be used to separate a mixture of compounds that contain 2 or more, 3 or more, or any number of different compounds in the mixture. The apparatuses and methods of the invention also enable separations that would ordinarily be impractical using conventional chromatography separations, for example, when there are very small differences in component retention factors.

It should be appreciated that apparatuses and methods of the invention are also applicable to ion-exchange chromatography, reversed phase chromatography, gas chromatography, as well as any other chromatography processes known to one skilled in the art.

There are many ways of changing the properties of a stationary phase. Exemplary methods or external stimuli that can be used in apparatuses and methods of the invention include, but are not limited to, electric field, irradiation, or a combination thereof.

When an electric field is used to modulate the polarity, appropriately designed electrodes are positioned around (or in) the column to apply the necessary electric field to effect or modulate the polarity of the stationary-phase (or the mobile phase). This may involve a static field or some type of oscillating field arrangement. Exemplary types of materials that can be used in an electric field modulated variable stationary or mobile phase include, but are not limited to, liquid crystals, charged group-functionalized solid-phase separation media, and electrorheological fluid materials.

Liquid crystals. Liquid crystals provide a well-known example of materials whose physical properties are altered by the application of an electric field. The liquid crystal molecules are functionalized such that in an aligned state (under the influence of an electric field) they present a surface to the mobile phase that is different to that in the unaligned state. See, for example, Taylor P. J. et al. Separation Science, 1971, 6, 841-853).

Charged Group-Functionalized Silica Gel. Methods for functionalizing silica are known to one skilled in the art. Many column adsorbents, with a range of different surface modifications, are commercially available. However, unlike conventional methods, some embodiments of the invention modify known solid-phase separation medium, such as silica, alumina, or zeolite, by attaching or immobilizing a zwitterion such as a compound of the formula: X-L-Y (Formula I). In Formula I, X is a cationic moiety, Y is an anionic moiety, and L is a linker having from about 2 to about 20 atom chain. Typically, the chain of atoms in L is independently selected from the group consisting of C, N, O, S, and P, provided the resulting compound is not unstable under chromatography conditions. Typically, it means no two same heteroatoms are present next the each other. Exemplary linkers include C₂-C₂₀ alkylene, C₂-C₂₀, alkenylene, C₂-C₂₀ alkynylene, each of which can optionally have one or more heteroatom, cycloalkylene, or heterocycloalkylene within the chain. As used herein, “alkylene” refers to a saturated divalent hydrocarbon moiety. Exemplary alkylene groups include, but are not limited to, methylene, ethylene, propylene, butylene, pentylene, and the like. “Alkenylene” refers to an alkylene as defined herein having one or more carbon-carbon double bond. “alkynylene” refers to an alkylene as defined herein having one or more carbon-carbon triple bond. “Cycloalkylene” refers to a non-aromatic, typically saturated, divalent mono- or bicyclic hydrocarbon moiety of three to ten ring carbons. The cycloalkylene can be optionally substituted with one or more substituents within the ring structure. “Heterocycloalkylene” refers to a divalent non-aromatic mono- or bicyclic moiety of three to ten ring atoms in which one or two ring atoms are heteroatoms selected from N, O, or S(O)ₙ (where n is an integer from 0 to 2), the remaining ring atoms being C, where one or two C atoms can optionally be a carbonyl group. The heterocycloalkylene ring can be optionally substituted independently with one or more substituents.

Other solid-phase separation media that can be used in the present invention include, but are not limited to, (1) Neutral (uncharged)) commercially available modified silica gels. For example—Silica gel, Chiral column packings (e.g. functionalized cellulose or amylose bonded to silica), Amino silica, Functionalized amino silica, Cyano silica, Diol silica, Phenyl silica, Substituted phenyl silica, Core-shell particles; and (2) Anionic or cationic materials (usually “resins”) that have for example bound anionic groups and mobile cations, or bound cationic groups and mobile counter anions. These are the materials typically used in “ion exchange” processes. There is then the further consideration of choosing/modifying the mobile counter ion.

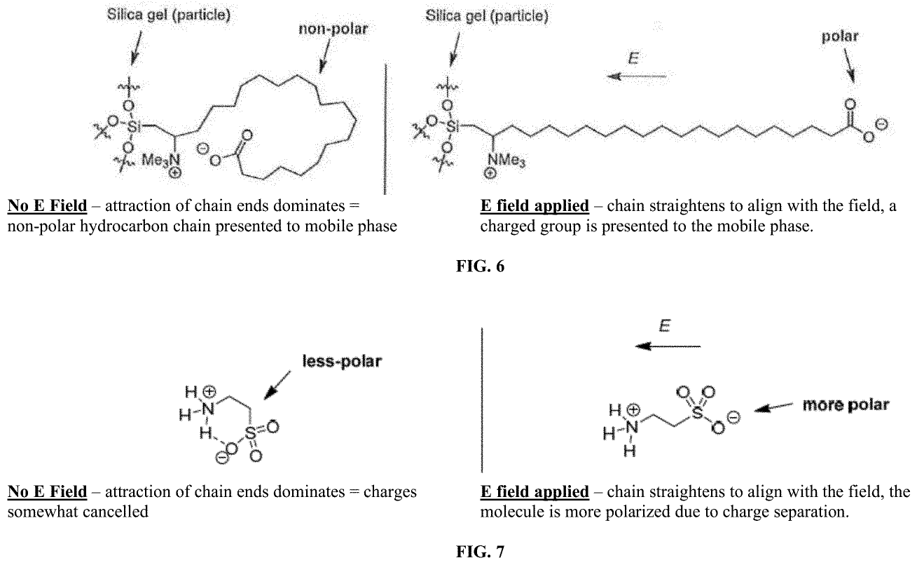

One particular zwitterion is shown in FIG. 6. In this particular embodiment, the zwitterion is covalently attached to the solid- or stationary phase. Any method of immobilizing the zwitterion can be used in the apparatuses and methods of the invention. Typically, in the absence of an electric field the zwitterion has the charged ends of the hydrocarbon chains attracted together, presenting a non-polar surface to the mobile phase. In the presence of an electric field, the linker L within the zwitterion straightens out to present a charged surface to the mobile phase. These polar/non-polar surface differences define the variable phase properties, e.g., polarity.

Electrorheological Fluid Materials. These materials are well-known to one skilled in the art and are used for many applications. Their distinguishing property is a change in viscosity (or shear yield stress) in the presence of an electric field. They are typically composed of suspensions of extremely fine non-conducting but electrically active particles. In magnetorheological fluid materials, fluid viscosity is affected by the amount of magnetic field which is typically controlled by using an electromagnet device. Similar to electrorheological fluid materials that use electric field strength to modulate the viscosity, the viscosity of magnetorheological fluid materials is varied or modulated using magnetic field strength. This change in viscosity can affect the rate of material flow through magnetorheological fluid materials, thereby allowing variable separation of different materials.

Similar to variable polarity stationary-phase, variable polarity mobile-phase utilizes the same eluent (i.e., chromatography solvent) composition but the polarity of the eluent is modulated using an external field generator or external field modulator. External field generators or external field modulators are well known to one skilled in the art. Exemplary external field generators or external field modulators include, but not limited to, voltage regulators such as variable transformers (for modulating either electric field strength and/or magnetic field strength), LASER (for modulating intensity of electromagnetic radiations), as well as other external field modulators known to one skilled in the art having read the present disclosure.

Changing the mobile phase polarity, without changing its chemical composition, as the separation is in progress, represents a distinctly different approach to chromatography. In its simplest form, a portion of the chromatography column zone (or zones) is operatively connected to an external field generator that can externally modulate or change a component of the eluent mixture from a low-polarity state to a high-polarity state (or vice-versa). In one embodiment, the eluent is a mixture consisting largely of an inert low polarity solvent component and a smaller amount of a component (e.g., zwitterion as disclosed herein) that can change from a low-polarity state to a high-polarity state, for example, under the influence of an electric field. In one particular embodiment, in the absence of the field, the solvent has low eluting power (normal phase chromatography), and in the presence of the field the solvent has high (at least somewhat higher than the other state, and can be tunable) eluting power. It should be appreciated, that the scope of the invention is not limited to using an inert or low polarity mobile-phase. As long as the stimulus reactive material can change the polarity or the separation power in chromatography, any suitable mobile-phase and/or stationary-phase materials can be used.

The variable polarity mobile-phase may be similar to some aspects as those disclosed above for variable polarity stationary-phase. While the “polarity modulating medium” (e.g., zwitterion) that is used to modulate the polarity of mobile-phase can be attached to the solvent molecule, typically the polarity modulating medium is not attached to the eluent but rather is admixed to provide a homogeneous solution. In this manner, only a small amount (e.g., ≤20%, typically ≤10%, often ≤5%, and more often ≤2% (v/v)) of polarity modulating medium relative to the chromatography solvent is used. A suitable zwitterion in variable polarity mobile-phase chromatography apparatuses and methods of the invention is the compound of Formula I defined above (e.g., X-L-Y, where X, L, and Y are those defined herein). One specific example of a polarity modulating medium is a compound shown in FIG. 6, which has the charged groups associate intramolecularly in the absence of an electric field, but stretch out to align with an applied electric field. The molecule exhibits a higher “polarity” when an electric field is applied.

In another embodiment, an electric field is used to modify the charge distribution in the solid phase material. This may produce a useful effect in a wide array of materials. Suitable materials include, but are not limited to, known or commercially available materials including silica gel, alumina, florisil, chiral column packings (e.g., functionalized cellulose or amylose bonded to silica), amino silica, functionalized amino silica, cyano silica, diol silica, phenyl silica, substituted phenyl silica, core-shell particles, corona-charged polypropylene fibers. In addition, chemical modifications to these materials using methods known to one skilled in the art, including functionalized amino silica, substituted phenyl silica, modified diol silica, etc. can also be used as the solid-phase.

In another embodiment, an electric field is used to modify the molecular alignment to modulate the polarity. In this embodiment, molecules align with the applied electric field (whether as part of the mobile phase or attached to the stationary phase). The bulk material difference between when the molecules are in the aligned state vs the random state modulates the mobile phase—stationary phase adsorption interaction. Many types of polar molecules exhibit this property. Such stimulus responsive materials can be zwitterions or polar neutral molecules. Exemplary polar neutral molecules include, but are not limited to, molecules having a functional group such as nitrile, aryl nitrile, carbonyl-containing groups, ether, polyether, amine, halide, or phosphoramide. Polar neutral molecules can be alkyl, alkenyl, aryl, alkynyl, heteroalkyl, heteroalkenyl, heteroaryl, etc.

Exemplary stimulus reactive materials that can be used in combination with irradiation include, azobenzene or other azoaromatic or azoheteroaromatic compounds, diarylethenes, diheteroarylethenes, quinones, spiropyrans, spirooxazines, etc. Covalently linking irradiation- or photo-switchable molecules to a stationary phase (e.g., silica gel) provides a method to change the nature of the substrate surface that is presented to the solvent. For example, azobenzene, i.e., molecules containing the azobenzene substructure, are known to undergo cis-trans isomerization upon irradiation with the appropriate light, typically UV light for the trans-cis conversion and blue light for the cis-trans conversion. See scheme I below:

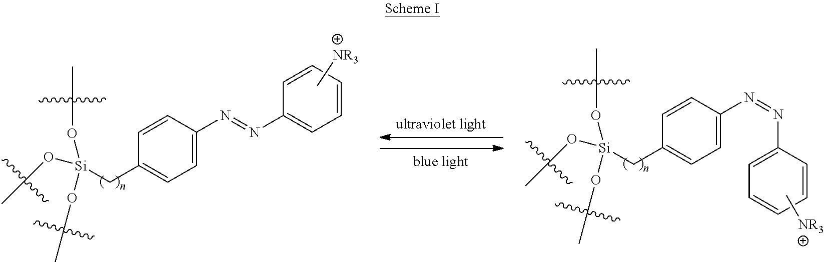

The large conformational cis-trans change alters (i.e., modulates) the adsorption properties of the surface. In some embodiments, one of the aromatic rings is anchored to the stationary-phase using linkers known to one skilled in the art and the other aromatic ring can be optionally substituted (ortho, meta, and/or para) with different groups. Substituents can be charged or neutral (e.g., alkyl, aryl, carbonyl-containing groups, nitrile, aryl nitrile, ether, poly-ether, amine, alkyl halide (chloride, fluoride), carboxylate, phosphate, sulfonate, sulfate, sulfonamide anion, borate, ammonium, iminium, pyridinium, imidazolium phosphonium, carbocation (e.g. triarylmethyl). It should be appreciated that one or more aryl group can be substituted with a heteroaryl group. In this manner, a wide variety of azoheteroaryl and azoaryl compounds can be used as stimulus responsive materials.

Other stimulus responsive materials that can be used to modulate the polarity using irradiation include, but are not limited to, diarylethenes, diheteroarylethenes, quinones (e.g. phenoxynaphthacene quinone), spiropyrans, spirooxazines, and other compounds known to one skilled in the art. See, for example, Scheme II.

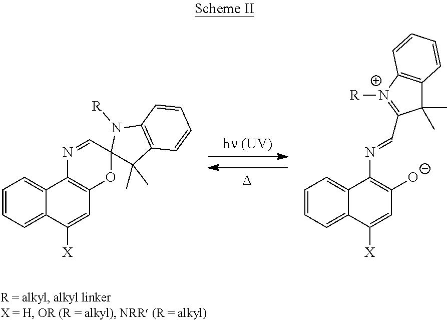

As can be seen in Scheme II, the conformation and charge distribution of stimulus responsive molecules can be modified by irradiation with different wavelengths of electromagnetic radiation. It should be appreciated that in Scheme II, alkyl or alkyl linker “R” as well “X” can be attached to other parts of the molecule. In addition, more than one R and/or X can be present in the compound. When more than one R and/or X is present, each R and/or X is independently selected.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

1. A chromatography apparatus comprising:
a chromatography column having a stationary-phase separation medium contained therein;
an external stimulus generator operatively connected to said chromatography column; and
a chromatography mobile-phase,
wherein at least one of said stationary-phase separation medium and said chromatography mobile-phase comprises a stimulus responsive material that adopts a different configuration based on the absence or the presence of said external stimulus, wherein different configurations of said stimulus responsive material results in a different stationary or mobile phase affinity, and wherein said external stimulus is selected from the group consisting of electric field, electromagnetic radiation, magnetic field, and a combination thereof.

2. The chromatography apparatus of claim 1, wherein said apparatus comprises a plurality of said external stimulus generators.

3. The chromatography apparatus of claim 1, wherein said apparatus comprises a plurality of said chromatography columns.

4. The chromatography apparatus of claim 1 further comprising a mobile-phase delivery device operatively connected to said chromatography column to deliver said mobile-phase to said chromatography column.

5. The chromatography apparatus of claim 4, wherein said mobile-phase delivery device is programmable.

6. The chromatography apparatus of claim 1, wherein said stimulus responsive material comprises an anionic moiety selected from the group consisting of carboxylate, phosphate, phosphonate, sulfate, sulfonate, sulfonamide anion, and borate.

7. The chromatography apparatus of claim 1, wherein said stimulus responsive material comprises a cationic moiety selected from the group consisting of a quaternary amine, iminium, pyridinium, imidazolium, phosphonium, sulfonium, and carbocation (e.g. triarylmethyl).

8. The chromatography apparatus of claim 1, wherein said stimulus responsive material is selected from a compound of the formula: X-L-Y, wherein X is a cationic moiety, Y is an anionic moiety, and L is a linker having from about 2 to about 20 atoms in a chain.

9. The chromatography apparatus of claim 1, wherein said stimulus responsive material is covalently attached to said solid-phase separation medium.

10. The chromatography apparatus of claim 1 further comprising a central processing unit and a sample analysis device, wherein said central processing unit is operatively connected to said sample analysis device, such that said central processing unit is programmed to modulate said stimulus generator based on the results obtained from said sample analysis device.

11. A method for purifying a mixture of compounds comprising at least a first compound and a second compound, said method comprising:
placing said mixture of compounds into a chromatography column of said chromatography apparatus of claim 1; and
separating at least a portion of said first compound from said second compound using an external stimulus to modulate the polarity of said stationary-phase separation medium or polarity of said mobile-phase or both.

12. The method of claim 11, wherein said external stimulus comprises an electric field, electromagnetic radiation or a combination thereof.

13. The method of claim 11, wherein said chromatography apparatus comprises a plurality of said external stimulus generators.

14. A solid-phase separation medium comprising a stimulus responsive material, wherein said stimulus responsive material is covalently attached to said solid-phase separation medium, and wherein said stimulus responsive material is capable of adopting different configurations based on the absence or the presence of an external stimulus, and wherein different configurations of said stimulus responsive material results in a different polarity of said solid-phase separation medium, and wherein said external stimulus is selected from the group consisting of electric field, electromagnetic radiation, magnetic field, or a combination thereof.

15. The solid-phase separation medium of claim 14, wherein said stimulus responsive material is selected from a compound of the formula: X-L-Y, wherein X is a cationic moiety, Y is an anionic moiety, and L is a linker having from about 2 to about 20 atoms in a chain, and wherein said solid-phase separation medium is covalently attached to L.

16. The solid-phase separation medium of claim 14, wherein said stimulus responsive material is a photoactive compound.

17. The solid-phase separation medium of claim 14, wherein said solid-phase medium comprises silica, alumina, zeolite, polymer, resin, or a combination thereof.

18. The solid-phase separation medium of claim 14, wherein said solid-phase medium comprises polystyrene, cross-linked polystyrene, dextran polymers, agarose, polyacrylamide, zeolite, or a combination thereof.

19. A composition comprising a zwitter ionic compound attached to a silica, wherein said composition is of the formula: 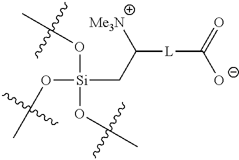
wherein L is a linker having from about 2 to about 20 atom chain.

20. The composition of claim 19, wherein L is C₂-C₂₀ alkylene, C₂-C₂₀, alkenylene, C₂-C₂₀ alkynylene, each of which can optionally have one or more heteroatom, cycloalkylene, or heterocycloalkylene within the chain.
